(19) United States
(12) Patent Application Publication
(10) Pub. No.: US 2002/0025818 A1
(43) Pub. Date: Feb. 28, 2002

(54) Method for allocating bandwidth in a wireless local area network and apparatus thereof

(75) Inventors: Hyun-Sook Kang, Suwon-city (KR); Kyung-Hun Jang, Suwon-city (KR)

Correspondence Address: SUGHRUE, MION, ZINN, MACPEAK & SEAS, PLLC, 2100 Pennsylvania Avenue, NW, Washington, DC, 20037-3213, US

(73) Assignee: SAMSUNG ELECTRONICS CO., LTD.

(21) Appl. No.: 09/915,766

(22) Filed: Jul. 27, 2001

(30) Foreign Application Priority Data
Aug. 26, 2000 (KR) 2000-49933

(51) Int. Cl. H04Q 7/20

(52) U.S. Cl. 455/450; 455/452

(57) ABSTRACT

Disclosed is a method for allocating a bandwidth in a wireless Local Area Network (LAN) including at least one wireless communication terminal and apparatus thereof, including the steps of: (a) the access point allocating a fixed bandwidth to the wireless communication terminal; (b) receiving a transmission rate corresponding to a desired Contention Free Period of data to be transceived from the terminal; and (c) adjusting a rate of Contention Free Period occupancy of the terminal in the bandwidth, based on the received transmission rate. According to the present invention, it is possible to allocate consistent bandwidth to terminals which are intended for real time data transmission.

### BACKGROUND OF THE INVENTION

1. Field of the Invention

This invention relates to a wireless Local Area Network (LAN), and more particularly, to a method for allocating bandwidth in a wireless LAN and apparatus thereof. The present application is based on Korean Patent Application No. 2000-49933, which is incorporated herein by reference.

2. Description of the Related Art

A wireless Local Area Network (LAN) transmits and receives data among terminals separated by a certain distance. In contrast to a general LAN, the wireless LAN does not require wiring on a floor, thus the terminals can be freely transported within the network.

Generally, the wireless LAN is classified as a Distribution System (DS) and an Ad hoc System.

FIG. 1 is a structural diagram for showing a wireless LAN. If a basic network unit, i.e. Basic Service Set (BSS), is constructed as the DS, a topology thereof is in a range where wireless communication terminals 10, 12, and 14, such as laptop computers, can be wirelessly connected with an Access Point (AP) 18.

The AP 18 can be connected both to communication lines and to a local ethernet backbone, such as ISDN, ATM or T1, which is connected to an external network such as the Internet. The AP 18 transmits synchronized information of a network, allocates bandwidth, and acts as a medium for transmitting data to a proximate BSS.

Meanwhile, in a BSS constructed as an Ad hoc System, each terminal of a network transmits synchronized information and allocates bandwidth.

Generally, in a DS network, the AP 18 indicates a Delivery Traffic Indication Message (DTIM), i.e. data transmission point for each terminal, to terminals which are subscribed to the network.

Also, a data transmission band is divided into a Contention Free Period (CFP) and a Contention Period (CP).

The CFP is a reserved period for transmitting/receiving real time data, such as audio and video data, with a high data transmission rate.

FIG. 2 is a timing diagram illustrating a bandwidth allocation in a conventional wireless LAN.

As shown in FIG. 2, the CFP has one DTIM and the CP has approximately two DTIMs , thus, three DTIMs are used in a first band T1.

In a Traffic Map, a synchronized frame is transmitted so that terminals may communicate with each other in one BSS. The synchronized frame transmits a beacon frame, including information of a present time and a signal which indicates data to be sent to a certain terminal.

Meanwhile, the CFP has one DTIM and the CP has one DTIM, thus, two DTIMs are used in a second band T2.

Accordingly, as shown in FIG. 2, in the conventional wireless LAN, the CP and CFP are not constantly allocated to a band, but variably allocated.

Therefore, it is a problem that the AP can not constantly allocate the bandwidth to the terminal that is intended for real time data transmission.

Also, it is difficult to transmit information in real time when an excessive number of terminals subscribe to one network unit, BSS, or when the subscriber terminal dominates large bandwidth in the CFP.

Therefore, in the conventional wireless LAN, real time data transmission is not guaranteed.

### SUMMARY OF THE INVENTION

It is an object of the present invention to provide a method for allocating bandwidth of a wireless Local Area Network (LAN) in such a manner that the bandwidth is constantly allocated to a terminal that is intended for a real time data transmission, a Contention Free Period (CFP) is adjusted based on a transmission rate of the terminal, and an occupancy time of the terminal is adjusted by providing a CFP occupancy limit.

It is another object of the present invention to provide an apparatus for allocating bandwidth of the wireless LAN.

According to the present invention, a method for allocating bandwidth in a wireless Local Area Network having an Access Point and at least one wireless communication terminal, comprising the steps of: (a) the Access Point allocating a fixed bandwidth to the wireless communication terminal; (b) receiving a transmission rate corresponding to a desired Contention Free Period of data to be transceived from the terminal; and (c) adjusting a rate of Contention Free Period occupancy of the terminal in the bandwidth, based on the received transmission rate. The step (a) is characterized in that the bandwidth is a sum of the Contention Free Period for real time data transmitting/receiving, and a Contention Period for non-real time data transmitting/receiving.

The step (b) is characterized in that the transmission rate provided by the terminal is a data packet length and a data transmission speed.

The step (c) comprises the steps of: calculating the Contention Free Period occupancy requested by the terminal; accepting the requested Contention Free Period occupancy as a current Contention Free Period occupancy if the Contention Free Period occupancy requested by the terminal does not exceed a Contention Free Period occupancy limit; and associating the terminal to the Access Point after adjusting a ratio of the Contention Free Period to Contention Period, if a sum of the current Contention Free Period occupancy is less than a maximum Contention Free Period.

An apparatus for allocating bandwidth in a wireless Local Area Network is provided, including at least one wireless communication terminal, comprising: bandwidth fixing means for fixing bandwidth to be allocated to a terminal; transmission rate receiving means for receiving a transmission rate of the terminal from the terminal, if the terminal is intended for a real time data transmission through a Contention Free Period; and period adjusting means for adjusting a rate of a Contention Free Period occupancy of the terminal in the bandwidth, based on the received transmission rate.

The bandwidth is a sum of the Contention Free Period for real time data transmitting/receiving, and a Contention Period for non-real time data transmitting/receiving.

The transmission rate provided by the terminal is a data packet length and a data transmission speed.

The period adjusting means comprises: calculating means for calculating the Contention Free Period occupancy requested by the terminal, based on the provided transmission rate; accepting means for accepting the requested Contention Free Period occupancy as a current Contention Free Period occupancy, if the Contention Free Period occupancy requested by the terminal does not exceed a Contention Free Period occupancy limit; and association means for associating the terminal to the Access Point after adjusting a ratio of the Contention Free Period to Contention Period, if a sum of the current Contention Free Period occupancy is less than a maximum Contention Free Period.

### BRIEF DESCRIPTION OF THE DRAWINGS

The objects and features of this invention will become apparent by the detailed descriptions of the preferred embodiment with reference to the attached drawings in which:

FIG. 1 is a structural diagram of a conventional wireless Local Area Network (LAN);

FIG. 2 is a timing diagram for showing a bandwidth allocation of a conventional wireless LAN;

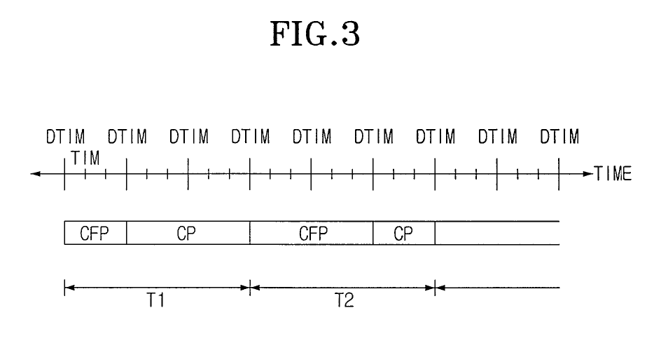

FIG. 3 is a timing diagram for showing a bandwidth allocation of a wireless LAN, according to the present invention; and FIG. 4 is a flow chart illustrating a method for allocating bandwidth of a wireless LAN, according to the present invention.

FIG. 5 is a structural diagram of an apparatus for allocating bandwidth in a wireless Local Area Network (LAN), according to the present invention.

### DETAILED DESCRIPTION OF THE PREFERRED EMBODIMENT

Hereinafter, the preferred embodiment of the present invention will be described in detail with reference to the attached drawings.

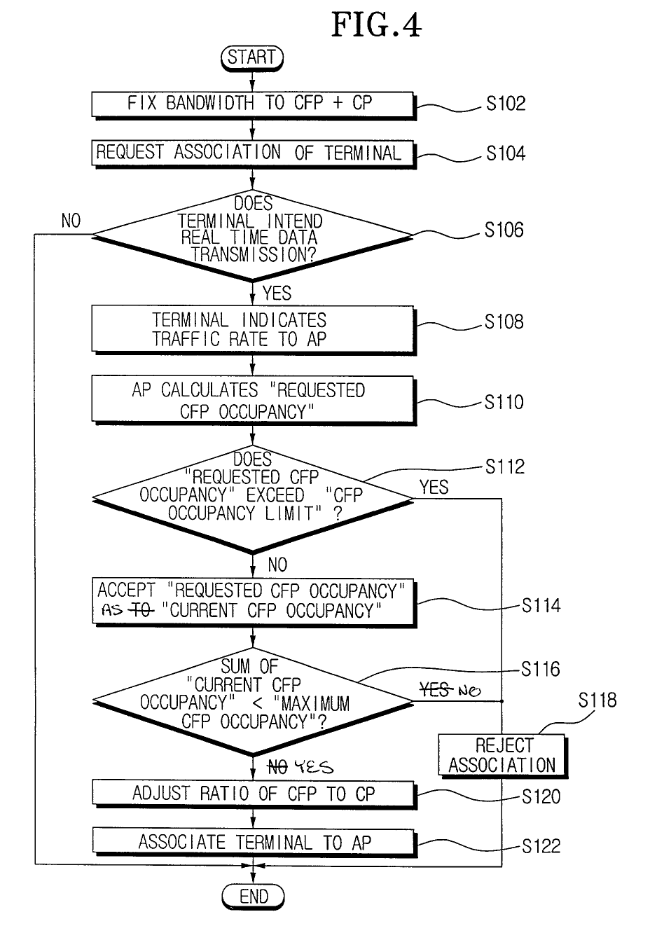

FIG. 3 is a timing diagram for showing a bandwidth allocation of a wireless Local Area Network (LAN), according to the present invention.

In a method for allocating bandwidth according to the present invention, identical range of bandwidth is allocated to each band.

As shown in FIG. 3, a Contention Free Period (CFP) has one Delivery Traffic Indication Message (DTIM) and a Contention Period (CP) has approximately two DTIMs in a first band T1, thus, three DTIMs are used in the first band T1.

Meanwhile, the next CFP has two DTIMs and the subsequent CP has one DTIM in a second band T2, thus, three DTIMs are used in the second band T2.

The number of DTIMs in the first and second bands T1 and T2 is the same, while the number of DTIMs in the CFP and CP of each of the respective bands is different.

Hereinafter, a method for allocating bandwidth in a wireless LAN, according to the present invention, will be described.

FIG. 4 is a flow chart illustrating a method for allocating bandwidth in a wireless LAN, according to the present invention.

First, as shown in FIG. 3, an Access Point (AP) fixes a bandwidth of a band (CFP+CP) to be allocated to the terminal (Step S102).

Next, the terminal which is intended for transmitting/receiving data to/from the AP requests an association or re-association to the AP (S104).

If it is determined that the terminal is intended for real time data transmission through the CFP (S106), a data packet length and a data transmission speed are indicated by the terminal during the association process (S108).

Then, the AP identifies a capacity and status of the terminals in the BSS to which the AP belongs.

Then, the AP calculates a CFP occupancy requested by the terminal (hereinafter referred to as “Requested CFP occupancy”) (S110). Here, a unit for the “Requested CFP occupancy” is a data packet length per a data transmission speed.

If the “Requested CFP occupancy” of the terminal exceeds a “CFP occupancy limit” (S112), the AP rejects the association of the terminal (S118). Here, the “CFP occupancy limit” is a limited time assigned to the terminals to prevent the terminals from occupying excessive area of the CFP.

However, if the “Requested CFP occupancy” does not exceed the “CFP occupancy limit”, the “Requested CFP occupancy” is accepted as a “Current CFP occupancy” (S114).

Then, it is determined whether a sum of the “Current CFP occupancy” is less than a “Maximum CFP” (S116). Here, the “Maximum CFP” is a maximum time for CFP occupancy in a fixed CFP and CP.

If the sum of the “Current CFP occupancy” is less than the “Maximum CFP”, a ratio of the CFP to CP is adjusted (S120). Then, the terminal is associated to the AP (S122).

If the sum of the “Current CFP occupancy” is greater than or equal to the “Maximum CFP”, the association of the terminal is rejected (S118).

Therefore, the method for allocating bandwidth in the wireless LAN, according to the present invention, can allocate consistent bandwidth to terminals intending a real time data transmission, and adjusts a ratio of the CFP to CP in a fixed bandwidth.

Also, the method for allocating bandwidth in the wireless LAN, according to the present invention, limits the range of occupancy of terminals within the “Maximum CFP occupancy” if there are increasing number of terminals which intend a real time data transmission through the CFP.

In the wireless LAN according to the present invention, the consistent range of bandwidth is allocated to the terminal which is intended for a real time data transmission.

Also, since the bandwidth between the CFP and the CP is adjusted based on traffic rate information of the terminal intending a real time data transmission, the data can be transmitted in real time in accordance with the traffic rate information of the terminal.

Even though the number of terminals intending a real time data transmission is increased, data can be transmitted in real time by limiting the CFP occupancy time.

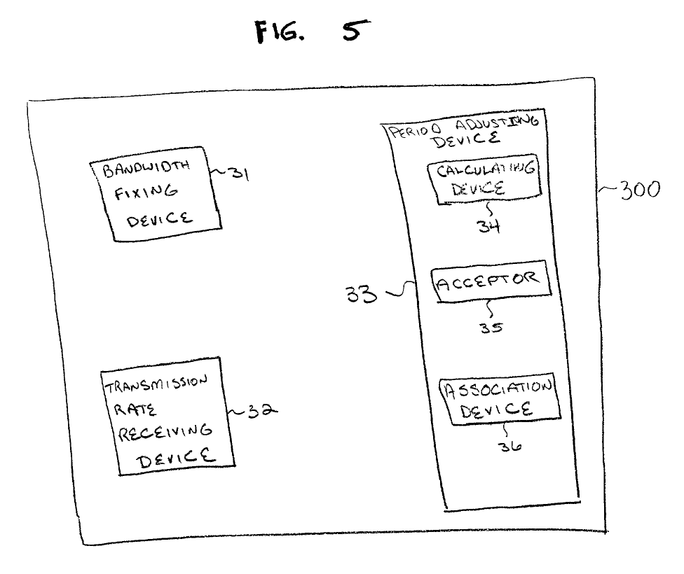

FIG. 5 is a structural diagram of an apparatus 300 for allocating bandwidth in a wireless Local Area Network (LAN), according to the present invention.

The apparatus 300 for allocating bandwidth in a wireless LAN includes a bandwidth fixing device 31, a transmission rate receiving device 32, and a period adjusting device 33.

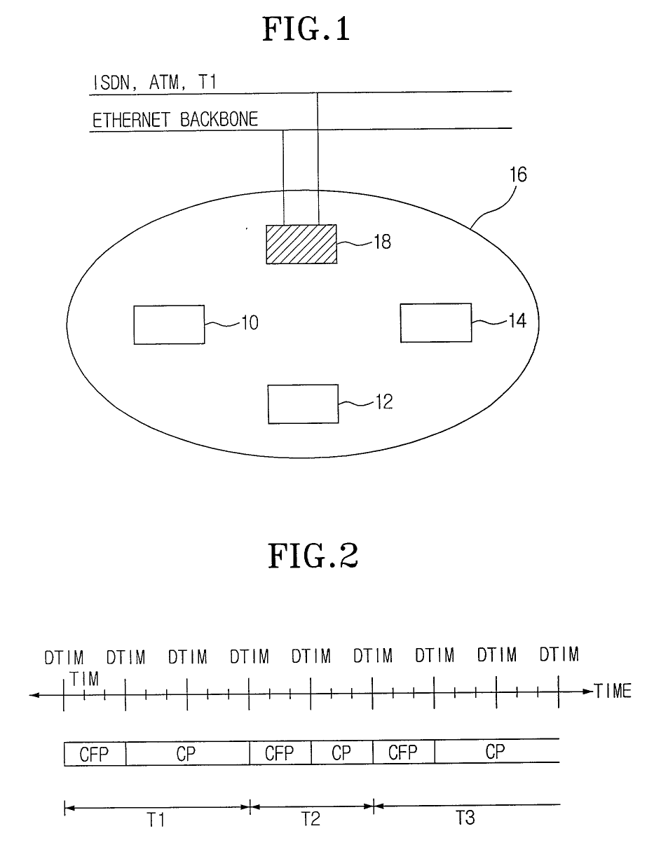

The bandwidth fixing device 31 fixes a bandwidth to be allocated to a terminal 10, shown in FIG. 1. The transmission rate receiving device 32 receives a transmission rate of the terminal from the terminal, if the terminal is intended for a data transmission. The period adjusting device 33 adjusts a rate of a Contention Free Period occupancy of the terminal in the bandwidth, based on the received transmission rate.

The period adjusting device 33 includes a calculating device 34, an acceptor 35, and an association device 36.

The calculating device 34 calculates the Contention Free Period occupancy requested by the terminal, based on the received transmission rate. The acceptor 35 accepts the requested Contention Free Period occupancy as a current Contention Free Period occupancy, if the Contention Free Period occupancy requested by the terminal does not exceed a Contention Free Period occupancy limit. Finally, the association device 36 associates the terminal to an Access Point 18, shown in FIG. 1, after adjusting a ratio of the Contention Free Period to Contention Period, if the sum of the current Contention Free Period occupancy is less than a maximum Contention Free Period.

It is to be understood, however, that even though the present invention has been described with reference to the attached drawings which depict the preferred embodiment thereof, the present invention is not limited to the said embodiment, and may apparently be modified in many ways by those ordinarily skilled in the art, without departing from the general principle and scope of the invention expressed in the appended claims.

What is claimed is:

1. A method for allocating bandwidth in a wireless Local Area Network having an Access Point and at least one wireless communication terminal, comprising the steps of:
(a) the Access Point allocating a fixed bandwidth to said at least one wireless communication terminal;
(b) receiving a transmission rate corresponding to a desired Contention Free Period of data to be transceived from said at least one wireless communication terminal; and
(c) adjusting a rate of Contention Free Period occupancy of said at least one wireless communication terminal in the fixed bandwidth, based on the received transmission rate.

2. The method of claim 1, wherein the data is real time data.

3. The method of claim 1, wherein in the step (a), the fixed bandwidth is a sum of the Contention Free Period for real time data transmitting/receiving, and a Contention Period for non-real time data transmitting/receiving.

4. The method of claim 1, wherein in the step (b), the transmission rate received from said at least one wireless communication terminal is a data packet length and a data transmission speed.

5. The method of claim 1, wherein the step (c) comprises the steps of:
calculating a Contention Free Period occupancy requested by said at least one wireless communication terminal;
accepting the Contention Free Period occupancy as a current Contention Free Period occupancy, if the Contention Free Period occupancy requested by said at least one wireless communication terminal does not exceed a Contention Free Period occupancy limit; and
associating said at least one wireless communication terminal to the Access Point after adjusting a ratio of the Contention Free Period to Contention Period, if a sum of the current Contention Free Period occupancy is less than a maximum Contention Free Period.

6. An apparatus for allocating bandwidth in a wireless Local Area Network, including at least one wireless communication terminal, comprising:
bandwidth fixing means for fixing bandwidth to be allocated to said at least one wireless communication terminal;
transmission rate receiving means for receiving a transmission rate of said at least one wireless communication terminal from said at least one wireless communication terminal, if said at least one wireless communication terminal is intended for a data transmission through a Contention Free Period; and
period adjusting means for adjusting a rate of a Contention Free Period occupancy of said at least one wireless communication terminal in the bandwidth, based on the received transmission rate.

7. The apparatus of claim 6, wherein the data is real time data.

8. The apparatus of claim 6, wherein the bandwidth is a sum of the Contention Free Period for real time data transmitting/receiving, and a Contention Period for non-real time data transmitting/receiving.

9. The apparatus of claim 6, wherein the transmission rate received from said at least one wireless communication terminal is a data packet length and a data transmission speed.

10. The apparatus of claim 6, wherein the period adjusting means comprises:
calculating means for calculating the Contention Free Period occupancy requested by said at least one wireless communication terminal, based on the received transmission rate;
accepting means for accepting the requested Contention Free Period occupancy as a current Contention Free Period occupancy, if the Contention Free Period occupancy requested by said at least one wireless communication terminal does not exceed a Contention Free Period occupancy limit; and
association means for associating the terminal to an Access Point after adjusting a ratio of the Contention Free Period to Contention Period, if a sum of the current Contention Free Period occupancy is less than a maximum Contention Free Period.
